(19) United States
(12) Patent Application Publication
(10) Pub. No.: US 2025/0124201 A1
(43) Pub. Date: Apr. 17, 2025

(54) AUTOMATIC CLOCK-GATING INSERTION IN REGISTER-TRANSFER LEVEL DESIGN

(71) Applicant: International Business Machines Corporation, Armonk, NY (US)

(72) Inventors: Maya Safieddine, Pflugerville, TX (US); David John Geiger, Poughkeepsie, NY (US); Ali S. El-Zein, Austin, TX (US); Viresh Paruthi, Austin, TX (US)

(21) Appl. No.: 18/485,461

(22) Filed: Oct. 12, 2023

(51) Int. Cl. G06F 30/327; G06F 30/3323

(52) U.S. Cl. CPC G06F 30/327; G06F 30/3323

(57) ABSTRACT

A computer-implemented method for inserting clock-gating in a register-transfer level (RTL) design is provided. The computer-implemented method includes flattening the RTL design, identifying modules and state elements in the RTL design, computing a clock-gating expression for each of the state elements of the RTL design, selecting terms of the clock-gating expression for each one of the state elements that is traceable to signals in a same one of the modules as the one of the state elements, determining which clock-gating terms are equivalent to those of other state elements in the RTL design, clustering state elements with equivalent clock-gating terms into clusters and inserting clock-gating logic, which equates to the equivalent clock-gating terms, into the RTL design for each cluster.

### BACKGROUND

The present invention generally relates to electronic design automation. More specifically, the present invention relates to improved techniques of integrated circuit (IC) design using automatic clock-gating insertion in register-transfer level (RTL) designs.

Modern processor and system-on-chip designs can include billions of transistors integrated within a semiconductor substrate. To design such large ICs, teams of designers typically employ sophisticated electronic design automation (EDA) tools, which assist the designers in defining and modeling the behavior of the overall IC (or subsets thereof) and developing a physical layout of a chip.

Hardware description languages (HDLs), such as VHDL or Verilog, enable the description of an IC design in a modular, hierarchical fashion. A module (or entity/architecture in VHDL) can describe one component of a modular circuit design by listing instances of subcomponents and the interconnections between the subcomponents. An instance can be a reference to a primitive circuit component (e.g., a logic gate or flip-flop) or a reference to another module. In the latter case, the instance, which can be referred to as a “module instance,” “child instance,” or “non-primitive instance,” directs the model construction process (e.g., logic synthesis) to substitute the contents of the referenced module for the instance. A hierarchical circuit design is one in which some module, called the top-level module, instantiates one or more other modules, which may in turn instantiate one or more other modules, and so on.

### SUMMARY

Embodiments of the present invention are directed to a computer-implemented method for inserting clock-gating in a register-transfer level (RTL) design is provided. A non-limiting example of the computer-implemented method for inserting clock-gating in an RTL design includes flattening the RTL design, identifying modules and state elements in the RTL design, computing a clock-gating expression for each of the state elements of the RTL design, selecting terms of the clock-gating expression for each one of the state elements that is traceable to signals in a same one of the modules as the one of the state elements, determining which clock-gating terms are equivalent to those of other state elements in the RTL design, clustering state elements with equivalent clock-gating terms into clusters and inserting clock-gating logic, which equates to the equivalent clock-gating terms, into the RTL design for each cluster.

Embodiments of the present invention are directed to a computer program product for inserting clock-gating in a register-transfer level (RTL) design, the computer program product including one or more computer readable storage media having computer readable program code collectively stored on the one or more computer readable storage media, the computer readable program code being executed by a processor of a computer system to cause the computer system to perform a method. A non-limiting example of the method includes flattening the RTL design, identifying modules and state elements in the RTL design, computing a clock-gating expression for each of the state elements of the RTL design, selecting terms of the clock-gating expression for each one of the state elements that is traceable to signals in a same one of the modules as the one of the state elements, determining which clock-gating terms are equivalent to those of other state elements in the RTL design, clustering state elements with equivalent clock-gating terms into clusters and inserting clock-gating logic, which equates to the equivalent clock-gating terms, into the RTL design for each cluster.

Embodiments of the invention are directed to a computing system including a processor, a memory coupled to the processor and one or more computer readable storage media coupled to the processor, the one or more computer readable storage media collectively containing instructions that are executed by the processor via the memory to cause the processor to perform steps for inserting clock-gating in a register-transfer level (RTL) design. The steps for inserting the clock-gating in the RTL design include flattening the RTL design, identifying modules and state elements in the RTL design, computing a clock-gating expression for each of the state elements of the RTL design, selecting terms of the clock-gating expression for each one of the state elements that is traceable to signals in a same one of the modules as the one of the state elements, determining which clock-gating terms are equivalent to those of other state elements in the RTL design, clustering state elements with equivalent clock-gating terms into clusters and inserting clock-gating logic, which equates to the equivalent clock-gating terms, into the RTL design for each cluster.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic diagram of a computing environment for executing a computer-implemented method for operating a chip handling assembly in accordance with one or more embodiments of the present invention;

FIG. 2 is a data flow diagram of a portion of a design methodology that transforms hardware description language (HDL) files to support various representations of an IC design in accordance with one or more embodiments of the present invention;

FIG. 3 is a flow diagram of a design methodology that transforms hardware description language (HDL) files to support various representations of an IC design in accordance with one or more embodiments of the present invention;

FIG. 4 is a graphical representation of an exemplary normalized HDL (NHDL) storage element in accordance with one or more embodiments of the present invention;

FIG. 5 is a flow diagram illustrating a computer-implemented method for inserting clock-gating in a register-transfer level (RTL) design in accordance with one or more embodiments of the present invention; and

FIG. 6 is a schematic diagram of a feedback loop and an associated MUXing structure in accordance with one or more embodiments of the present invention;

FIG. 7 is a flow diagram illustrating an operation of the computer-implemented method of FIG. 6 in accordance with one or more embodiments of the present invention; and

FIG. 8 is a diagram illustrating a hardware description language (HDL) file, a normalized HDL file and clock-gating insertion in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

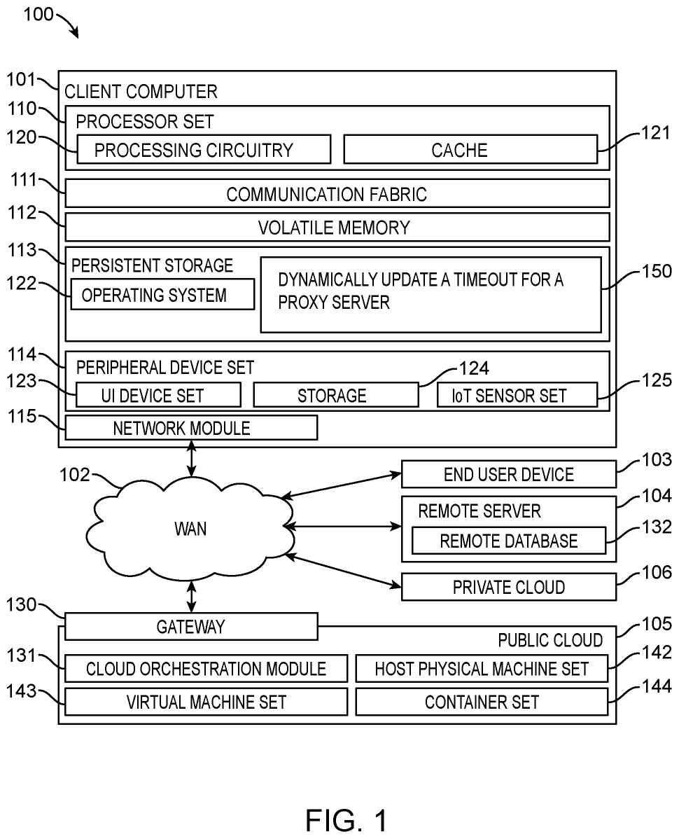

With reference to FIG. 1, a computer or computing device 100 that implements a computer-implemented method for inserting clock-gating in a register-transfer level (RTL) design. The computer or computing device 100 of FIG. 1 contains an example of an environment for the execution of at least some of the computer code involved in performing the inventive methods, such as the block 1001 of the computer-implemented method for inserting the clock-gating in the RTL design. In addition to the computer-implemented method for inserting the clock-gating in the RTL design of block 1001, the computer or computing device 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the computer-implemented method of block 1001, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

The computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of the computer-implemented method, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

The processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In the computer-implemented method, at least some of the instructions for performing the inventive methods may be stored in the block 1001 of the computer-implemented method in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the block 1001 of the computer-implemented method typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Turning now to an overview of technologies that are more specifically relevant to aspects of the invention, clock-gating is a key element of saving power in electronic circuits. A particularly pathological source of high power consumption are state-holding elements, such as latches, which consume power every time they “switch” (i.e., the element transfers the value on its input to its output which is then retained subsequently as the “state” via a feedback loop). The idea behind clock-gating is to not switch state-holding elements, such as latches, when the input to it does not change or the new value will not be used later, as doing so would effectively be a no-op while burning power by way of switching. This is achieved by gating the clock to the latch off in situations where the above holds true.

Present day automation tools, such as synthesis, are powerful enough to figure out clock-gating conditions, and implement the final circuit in a manner such that the power savings are realized. And given this, IPs, such as the RISC-V core, do not implement aggressive clock-gating in the RTL; instead deferring this to the synthesis tools whenever the IP gets “processed” by the synthesis tool. The problem with this approach is the fact that insertion of clock-gating is deferred to much later stages of the project, and the designer loses control over implementing it with his/her deep insight and knowledge. Moreover, an ability to measure the effectiveness (e.g., proxy power numbers for the final design obtained by analyzing the RTL) of the clock-gating early on and/or making sense of it versus back-annotating it from the synthesized circuit can be a tremendously difficult task.

Turning now to an overview of the aspects of the invention, one or more embodiments of the invention address the above-described shortcomings of the prior art by providing a clock-gating solution. In the clock-gating solution, clock-gating conditions are inserted in the RTL along with an RTL transformation-based design (RTBD) system which manipulates the RTL. The RTL is analyzed clock-gating conditions are inferred. The clock-gating condition are then generated as logic to be inserted into the RTL automatically. This yields a modified design RTL source which can then be subjected to various typical analyses. This allows for the designers, who are the most knowledgeable, to add/tweak the clock-gating conditions manually and present it to the system to re-generate the modified RTL. Furthermore, the correctness of the clock-gating is automatically verified by equivalence checking. In addition, the clock-gating solution optimizes clock-gating for an entire unit versus physical blocks, which contrasts with backend-oriented methods that lack knowledge of a larger scope.

The above-described aspects of the invention address the shortcomings of the prior art by providing a computer-implemented method for inserting clock-gating in an RTL design. The computer-implemented method includes flattening the RTL design, identifying modules and state elements in the RTL design, computing a clock-gating expression via structural analysis for each of the state elements of the RTL design, selecting terms of the clock-gating expression for each one of the state elements that is traceable to signals in a same one of the modules as the one of the state elements, determining which clock-gating terms are equivalent to those of other state elements in the RTL design, clustering state elements with equivalent clock-gating terms into clusters and inserting clock-gating logic, which equates to the equivalent clock-gating terms, into the RTL design for each cluster.

Turning now to a more detailed description of aspects of the present invention, a data processing system, such as the computer 101 of FIG. 1, includes a processor that processes data under the direction of program instructions. The processor is communicatively coupled to other components of data processing system, such as a network interface, input/output (I/O) devices and data storage. The data storage may include volatile and/or non-volatile storage media and can store software (or program code) containing program instructions executable by the processor, data to be processed by the processor and data produced by the processing performed by processor.

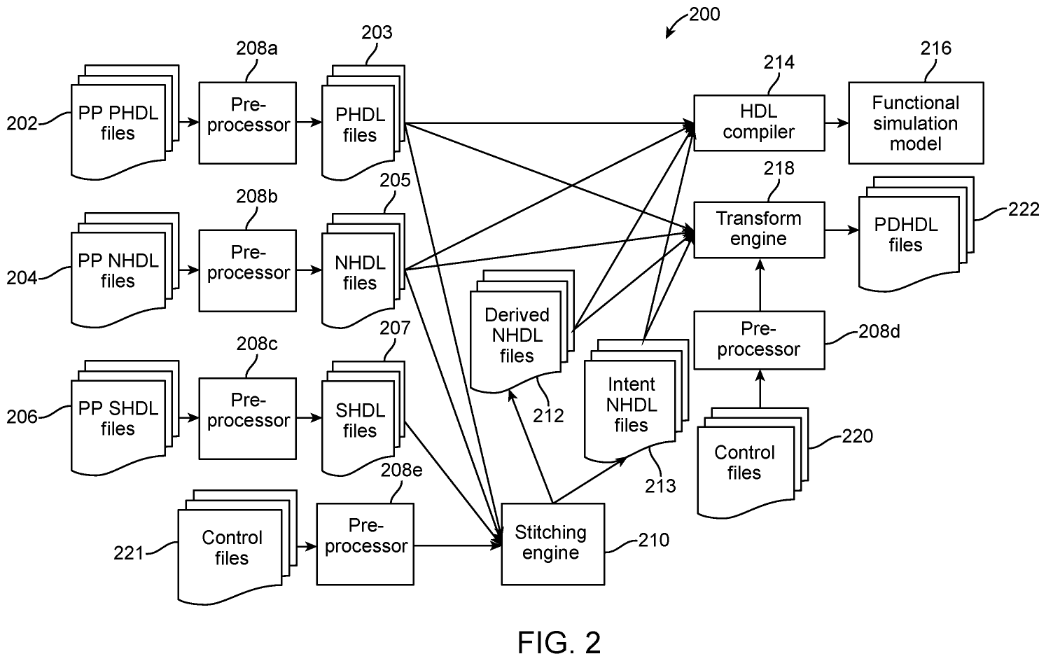

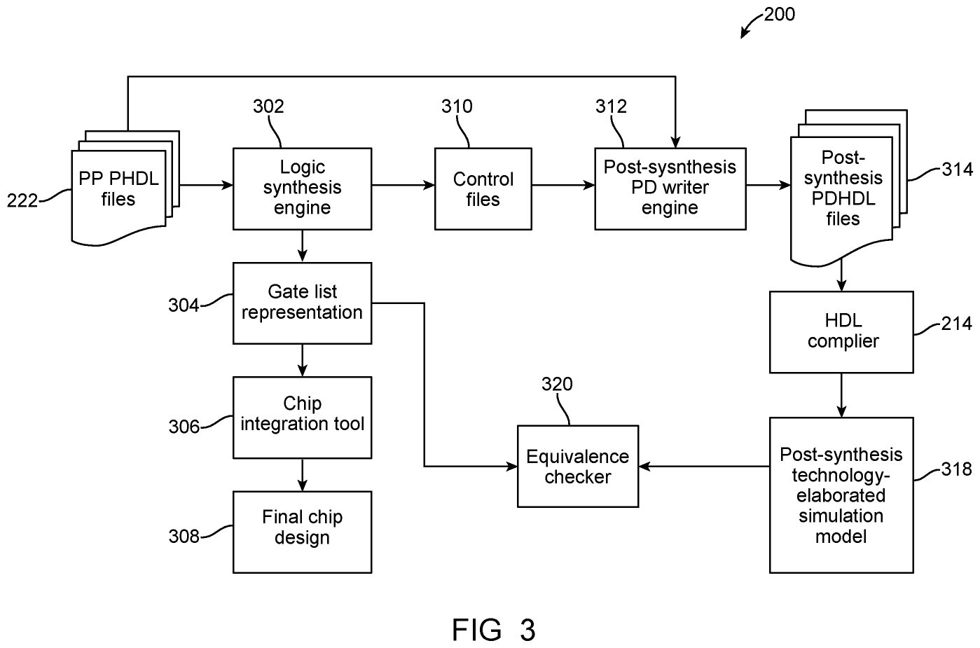

With reference to FIGS. 2 and 3, as an example, the data storage can store one or more design tools that include, among others, a stitching engine 210, a transform engine 218, an HDL compiler 214, a logic synthesis engine 302, a chip integration tool 306 and a PD writer engine 312. When executed by the processor, the design tool may receive, as inputs, one or more design files and possibly one or more control files, such as control files 220, 221 and 310 described below. For example, input design files can include one or more hardware description language (HDL) files defining an integrated circuit design. Control files can include one or more files specifying attributes of or constraints for an IC design or its processing by design tools. By executing the design tools, the processor can generate as outputs, among other things, new and/or updated design files, various simulation models of an IC design (or portion thereof), gatelist representations of an IC design (or portion thereof), etc. It will be appreciated by those skilled in the art that in some embodiments, some or all of the design tools, design files and control files may alternatively or additionally be stored on storage media external to the data processing system that is accessible to the processor, for example, via a network interface.

With continued reference to FIGS. 2 and 3, there are depicted data flow diagrams of an exemplary end-to-end design methodology 200 for transforming HDL files to support various representations of an IC design. Design methodology 200 begins with design files and can generate a final physical integrated circuit chip design and a logically equivalent simulation model.

It is to be appreciated that a single model of a design throughout the design process may be suboptimal because no one model can satisfy the needs of all of the different constituencies involved in the design process. For example, logic designers responsible for developing the functional operation of the design may prefer the design to reflect an organizational hierarchy of entities (each of which is represented by a specific HDL file) that is structured around the logical makeup of the design and the allocation of responsibility for developing the functions within the design among various logic designers. On the other hand, physical designers, who bear responsibility for laying out a floorplan for a physical design as realized in integrated circuitry, may desire to use a model that is organized based on boundaries for placeable floorplan objects and logic synthesis boundaries rather than logic functions. As one example, during physical design, a number of smaller logic entities, possibly assigned to different designers, may be combined into a larger entity (i.e., a so-called “large-block”) that is run through logic synthesis to create a placeable set of logic for the chip design. Performing synthesis on this large-block allows the logic synthesis tool to perform better optimizations over a larger portion of the design than would be possible if each of the individual smaller entities were synthesized alone. However, the hierarchical organization necessary to allow this large block synthesis is incompatible with the hierarchy organization preferred by logic designers, which would separate the various entities into enclosing entities based on design responsibility.

The depicted design methodology 200 supports various different types of input modular design files, which can be created or derived from inputs provided by logic designers involved in the development of an integrated circuit design. In this example, the types of modular design files that can be utilized in design methodology 200 include at least PHDL files 203, NHDL files 205 and SHDL files 207.

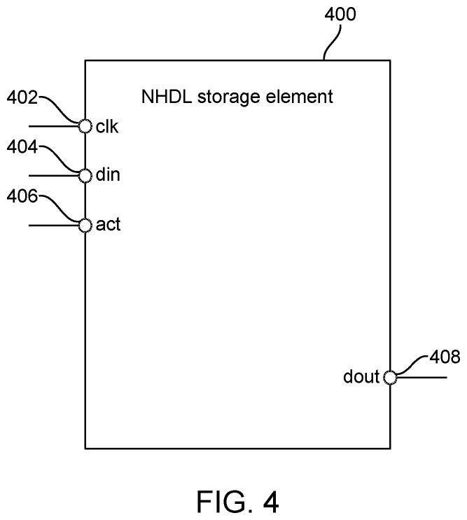

NHDL (“normalized” HDL) files 205 refer to HDL files that follow all the conventions and requirements of a native HDL. By convention, NHDL files 205 simplify or “normalize” out elements other than those that support the design's functional intent. For example, in a NHDL file 205, a simplified or abstract storage element, which can be used to generically represent the function of a latch or storage element, is driven by a generic single phase logical clock signal (e.g., as shown in FIG. 4). This abstract storage element also provides for clock-gating. However, storage elements in NHDL files 205 omit more complex technology-specific multi-phase clocking signals used in many technologies and the associated technology-specific clock control structures that will be present in the final realization of the integrated circuit. By employing simplified storage elements, the complexity of a functional simulation model 216 derived from NHDL files is significantly reduced, thus allowing for more efficient simulation of the functional intent of the design.

In some embodiments, the depicted process also supports PP NHDL (pre-processor NHDL) files 204. PP NHDL files 204 may be pseudo-NHDL files that include pre-processor constructs that are expanded and elaborated by a pre-processor 208b to create expanded legal NHDL files 205. Pre-processor 208b may support, among other things, looping constructs to unwind a simple description into a number of similar replicated blocks of HDL code. When such pre-processor directives are present, PP NHDL files 204 are typically not directly usable by an HDL compiler (e.g., HDL compiler 214) until pre-processor 208b has processed PP NHDL files 204 into NHDL files 205. If a PP NHDL file 204 has no pre-processor directives (they are not required), the corresponding NHDL file 205 is the same as the associated PP NHDL file 204.

While NHDL files 205 provide significant reductions in complexity and lower code entry overhead for designers, additional complexity reductions and entry overhead efficiency can optionally be achieved using a type of HDL files referred to herein as SHDL (“simplified” HDL) files 207. SHDL files 207 include one or more statements employing a unique simplified syntax. For example, the simplified syntax employed in SHDL files 207 provides a significant simplification for the entry of storage elements (e.g., latches). In addition, the syntax of SHDL files 207 can be utilized to automate certain overhead functions like signal declaration and port map elaboration. SHDL files 207 may have a corresponding set of PP SHDL (pre-processor SHDL) files 206 that are processed by a pre-processor 208c to produce legal SHDL files 207 for those PP SHDL files 206 including pre-processing directives as described above.

In some cases, additional HDL files, referred to herein as PHDL (“physical” HDL) files 203, may also be employed. A PHDL file 203 more fully defines an entity, for example, by specifying not only the functional components of the entity, but also by specifying a substantially complete representation of the various technology-specific structures within the entity. Like NHDL files 205, PHDL files 203 are legal files for a selected native HDL that can be directly compiled by an HDL compiler 214 and follow all syntactic and semantic rules for the native HDL. Unlike NHDL files 205, PHDL files 203 contain technology-specific signals and instances of technology-specific support structures and do not make use of abstract or simplified storage elements. In general, the difference between PHDL files 203 and NHDL files 205 is one of convention about the structures used and the set of control signals involved. In accordance with at least some embodiments, a special set of conventions can be employed to allow entities defined by PHDL files 203 to coexist in the same simulation model with entities defined by NHDL files 205 and SHDL files 207. As with NHDL files 205 and SHDL files 207, PHDL files 203 can optionally be derived from corresponding PP PHDL (pre-processor PHDL) files 202 by a pre-processor 208a.

NHDL files 205 and PHDL files 203 can be directly processed by a HDL compiler 214 to include instances of the entities defined by such files in a functional simulation model 216. While NHDL files 205 and PHDL files 203 can be directly processed by the HDL compiler 214 (because they follow the full syntactic and semantic rules of the native HDL being employed), SHDL files 207 cannot be directly processed by HDL compiler 214. In order to permit instances of entities defined by SHDL files 207 to be included in functional simulation model 216, the content of each SHDL file 207 is processed by a stitching engine 210 to, among other things, convert simplified SHDL storage element instantiations found within the SHDL file 207 into NHDL storage element instantiations, connect clock signals to those NHDL storage elements, elaborate port maps on entities instantiated by the SHDL entity and/or provide necessary signal declarations to produce a legal derived NHDL file 212 for the given SHDL file 207. The stitching engine 210 performs these functions by examining PHDL files 203, NHDL files 205 and SHDL files 207 to determine the proper ports to be added to a SHDL entity to clock the newly instantiated NDHL storage element(s) and to properly elaborate the port maps for the NHDL and/or SHDL entity or entities instantiated within the SHDL entity. As a result of this processing, stitching engine 210 generates derived NHDL files 212, which are passed to the HDL compiler 214 along with PHDL files 203 and NHDL files 205 to be compiled to produce a functional simulation model 216. The stitching engine 210 additionally processes expressions of the logic designer's intent in refinement found within NHDL files 205 and SHDL files 207 to produce to a set of intent NHDL files 213. The expression of designer's intent set forth in NHDL files 205 and SHDL files 207 can be subsequently overridden by directives in control files 221, which may be pre-processed prior to input into stitching engine 210 by a pre-processor 208c. As indicated, intent NHDL files 213 may also be provided as an input to the HDL compiler 214 to control the generation of a functional simulation model 216.

Derived NHDL files 212, NHDL files 205, PHDL files 203 and intent NHDL files 213 may alternatively or additionally be processed by a transform engine 218. The transform engine 218 transforms these HDL files into “physical design” HDL (PDHDL files) 222 defining a physical representation of the integrated circuit design complete with technology-dependent pervasive and other non-functional-intent structures. The operation of the transform engine 218 can be controlled by control files 220, which may, for example, include various “recipes” for controlling the creation of the integrated circuit design. As indicated, in some embodiments, control files 220 may optionally be processed by a pre-processor 208d to unroll code or support other optimizations.

As shown in FIG. 3, the design methodology 200 continues by further processing the integrated circuit design, which is now fully defined by PDHDL files 222. The PDHDL files 222 are processed by a logic synthesis engine 302 to create a realizable IC design from the functions described in the PDHDL files 222. During this process, various simple optimizations/alterations may be made to the various pervasive structures added to the design to produce the PDHDL files 222. In particular, the scan chain among a set of storage elements may be reordered based on the assigned physical placement of the storage elements in the integrated circuit floorplan. Logic synthesis engine 302 produces a gate list representation 304 of the integrated circuit design. This gate list representation 304 can then be processed by a chip integration tool 306 to produce a detailed final chip design 308 representing the exact circuit layouts on the various layers within the IC, which may be fabricated in an IC chip utilizing the selected technology node.

The processing of PDHDL files 222 by the logical synthesis engine 302 additionally generates control files 310 that document the changes to the design imposed by the logic synthesis engine 302. These changes are then utilized by post-synthesis physical design (PD) writer engine 312 to update the PDHDL files 222 to obtain post-synthesis PDHDL files 314. It is important to note that post-synthesis PDHDL files 314 still represent the IC design in a set of fully legal HDL files defining the design utilizing native HDL syntax rather than as a “flattened” collection of gates (as in gate list representation 304). However, post-synthesis PDHDL files 314 do include within the design all the technology-specific support structures, such as pervasive logic structures. As such, when post-synthesis PDHDL files 314 are compiled by an HDL compiler 316, the resultant post-synthesis technology-elaborated simulation model 318, which can be utilized to simulate a physical realization of the design, is (or should be) fully equivalent in behavior to the gate list representation 304 generated by logic synthesis engine 302. This equivalence can be formally verified, for example, by an equivalence checker 320.

With reference now to FIG. 4, a graphical representation of an exemplary NHDL storage element 400 is provided. The NHDL storage element 400 (e.g., a latch) provides a minimum set of ports to support a functional intent for NHDL storage element 400. These ports (represented in each of the figures by a dot on the boundary of an entity or storage element) include a clock port (clk) 402, a clock gate port (act) 406, a data input port (din) 404, and a data output port (dout) 408. It should be noted that NHDL storage element 400 omits any and all technology-specific ports, so that NHDL storage element 400 can serve as a minimum canonical form of a storage element.

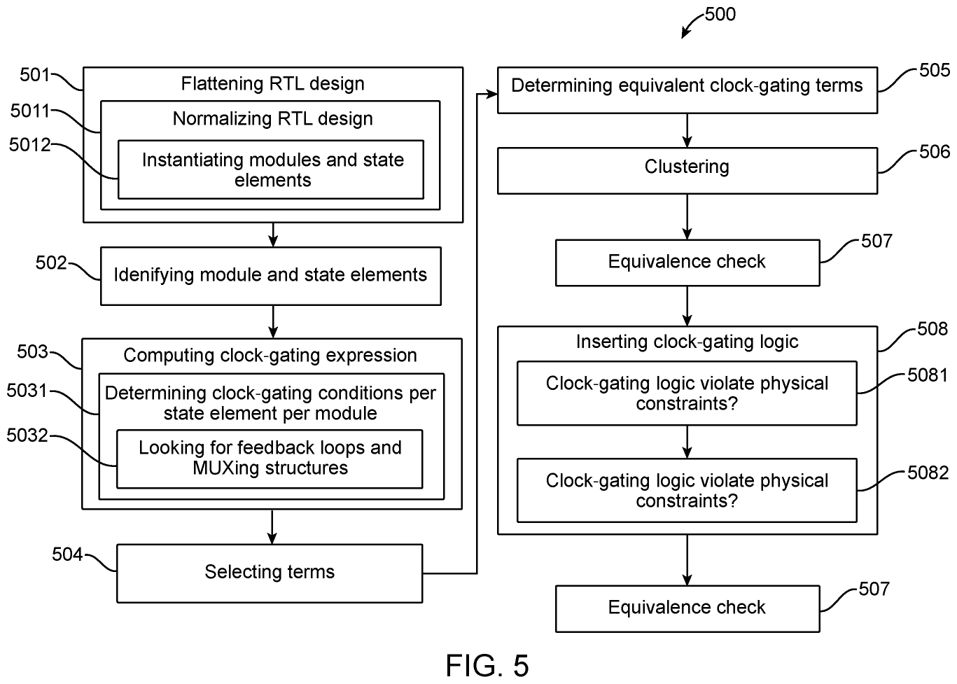

With reference to FIG. 5, a computer-implemented method 500 for inserting clock-gating in an RTL design, such as NHDL files 222 of FIG. 3, is provided. The computer-implemented method 500 includes flattening the RTL design into, for example, the gate list representation 304 of FIG. 3 (block 501) and identifying modules and state elements, such as latches, in the RTL design (block 502). The flattening of the RTL design of block 501 can include normalizing the RTL design (block 5011), which, in turn, can include instantiating each of the state elements (block 5012).

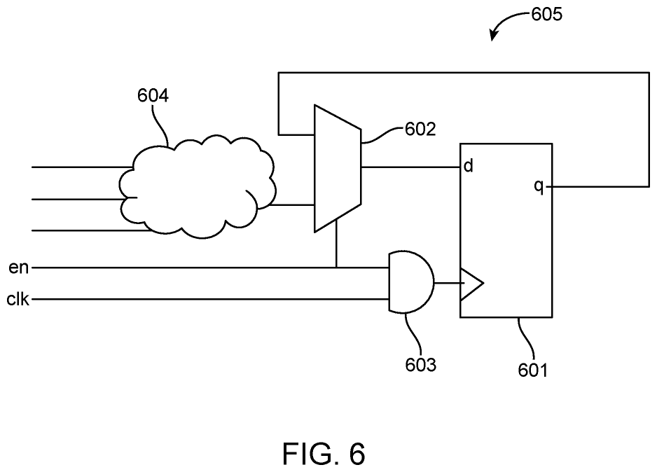

The computer-implemented method 500 can also include computing a clock-gating expression via results of structural analysis associated with the identifying of the modules and state elements of block 502 for each of the state elements of the RTL design (block 503) and selecting terms of the clock-gating expression for each one of the state elements that is traceable to signals in a same one of the modules as the one of the state elements (block 504). The computing of the clock-gating expression of block 503 can include determining clock-gating conditions per state element per module via the structural analysis (block 5031) and the determining of the clock-gating conditions of block 5031 can include looking in the gate list representation 304, for example, for a feedback loop and an associated MUXing structure (block 5032) as shown in FIG. 6 to be described below.

The computer-implemented method 500 further includes determining which clock-gating terms are equivalent to those of other state elements in the RTL design (block 505), clustering state elements with equivalent clock-gating terms into clusters that can span across hierarchies in certain cases (block 506) and inserting clock-gating logic, which equates to the equivalent clock-gating terms, into the RTL design for each cluster (block 507) The computer-implemented method 500 can also include equivalence checking of each of the modules prior to and following the inserting of the clock-gating logic (block 508) to be executed by the equivalence checker 320 of FIG. 3, for example, prior to and following the inserting of the clock-gating logic of block 508. The inserting of the clock-gating logic of block 508 can include determining whether the clock-gating logic violates physical constraints (block 5081) and externally waiving of the inserting in cases in which the clock-gating logic is determined to violate physical constraints (block 5082).

With reference to FIG. 6, a feedback loop and an associated MUXing structure 600 is provided and includes a state element 601, such as a latch or a collection of latches, a MUXing element 602, an ANDing element 603 and clock logic 604. The ANDing element 603 is receptive of an enable signal en and a clock signal clk, which can also be provided to the next-state logic 604 along with other signals, and is configured to output a latch signal to the state element 601. A feedback loop 605 is formed from an output of the state element 601 being output from port q and input to the MUXing element 602 along with next-state logic 604 and the MUXing element 602 outputting a MUX signal to the input port d. The next-state logic 604 is the next value which will get loaded into the state element 601. This occurs when the enable signal en selects this value in the MUX element 602 and the clock signal clk clocks. With clock-gating because of the ANDing of the enable signal en with the clock signal clk, the clock signal clk will not clock at the state element 601 when the enable signal en is not selecting the next-state value.

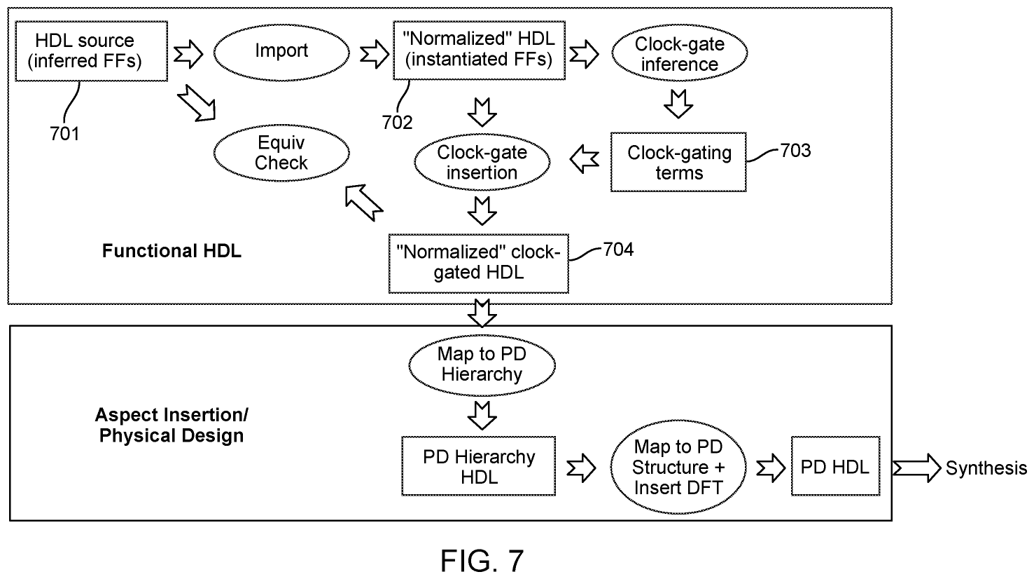

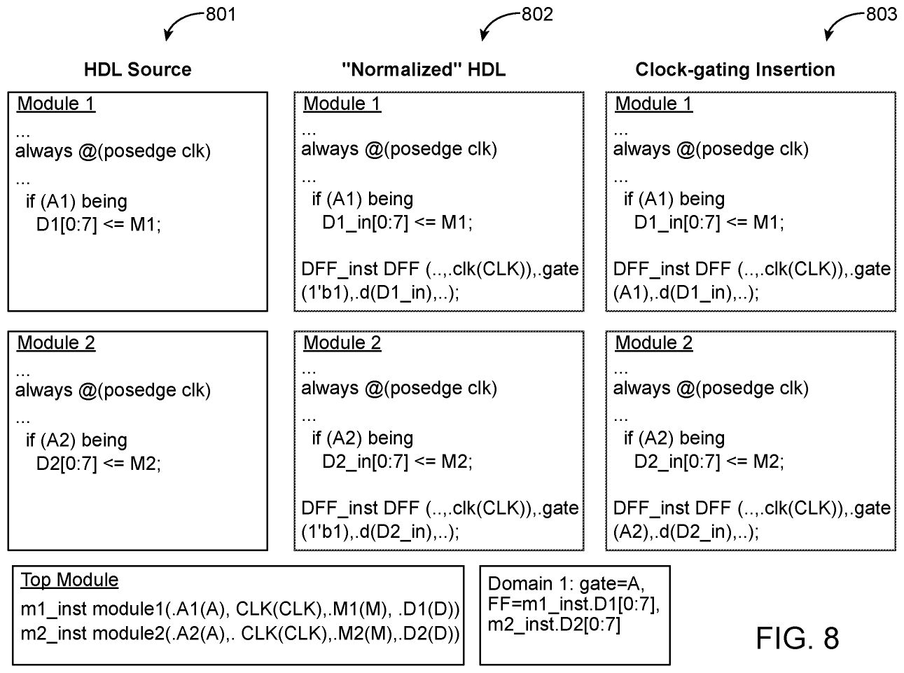

With reference to FIGS. 7 and 8, an operation of the computer-implemented method 500 of FIG. 5 is provided. As shown in FIG. 7, an HDL source (HDL source 801 of FIG. 8) is received at block 701 and imported as a normalized HDL file (normalized HDL file 802 of FIG. 8) at block 702. Following clock-gate inference, clock-gating terms are generated at block 703 and inserted into the normalized HDL file (as in clock-gating insertion 803 of FIG. 8). The normalized clock-gated HDL at block 704 can then be subject to equivalence checking and, once the equivalence checking is passed, can be mapped into PDHDL files 222 of FIGS. 2 and 3, for example, for subsequent synthesis.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having.” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The term “conformal” (e.g., a conformal layer) means that the thickness of the layer is substantially the same on all surfaces, or that the thickness variation is less than 15% of the nominal thickness of the layer.

The terms “epitaxial growth and/or deposition” and “epitaxially formed and/or grown” mean the growth of a semiconductor material (crystalline material) on a deposition surface of another semiconductor material (crystalline material), in which the semiconductor material being grown (crystalline overlayer) has substantially the same crystalline characteristics as the semiconductor material of the deposition surface (seed material). In an epitaxial deposition process, the chemical reactants provided by the source gases can be controlled and the system parameters can be set so that the depositing atoms arrive at the deposition surface of the semiconductor substrate with sufficient energy to move about on the surface such that the depositing atoms orient themselves to the crystal arrangement of the atoms of the deposition surface. An epitaxially grown semiconductor material can have substantially the same crystalline characteristics as the deposition surface on which the epitaxially grown material is formed. For example, an epitaxially grown semiconductor material deposited on a {100} orientated crystalline surface can take on a {100} orientation. In some embodiments of the invention, epitaxial growth and/or deposition processes can be selective to forming on semiconductor surface, and cannot deposit material on exposed surfaces, such as silicon dioxide or silicon nitride surfaces.

As previously noted herein, for the sake of brevity, conventional techniques related to semiconductor device and integrated circuit (IC) fabrication may or may not be described in detail herein. By way of background, however, a more general description of the semiconductor device fabrication processes that can be utilized in implementing one or more embodiments of the present invention will now be provided. Although specific fabrication operations used in implementing one or more embodiments of the present invention can be individually known, the described combination of operations and/or resulting structures of the present invention are unique. Thus, the unique combination of the operations described in connection with the fabrication of a semiconductor device according to the present invention utilize a variety of individually known physical and chemical processes performed on a semiconductor (e.g., silicon) substrate, some of which are described in the immediately following paragraphs.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), and chemical-mechanical planarization (CMP), and the like. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for inserting clock-gating in a register-transfer level (RTL) design, the computer-implemented method comprising:
flattening the RTL design;
identifying modules and state elements in the RTL design;
computing a clock-gating expression for each of the state elements of the RTL design;
selecting terms of the clock-gating expression for each one of the state elements that is traceable to signals in a same one of the modules as the one of the state elements;
determining which clock-gating terms are equivalent to those of other state elements in the RTL design;
clustering state elements with equivalent clock-gating terms into clusters; and
inserting clock-gating logic, which equates to the equivalent clock-gating terms, into the RTL design for each cluster.

2. The computer-implemented method according to claim 1, wherein:
the flattening of the RTL design comprises normalizing the RTL, and
the normalizing of the RTL comprises instantiating each of the state elements.

3. The computer-implemented method according to claim 1, wherein the state elements comprise latches.

4. The computer-implemented method according to claim 1, wherein:
the computing of the clock-gating expression comprises determining clock-gating conditions per state element per module via a structural analysis, and
the determining of the clock-gating conditions comprises looking for a feedback loop and an associated MUXing structure.

5. The computer-implemented method according to claim 1, wherein the clustering is executed across hierarchies.

6. The computer-implemented method according to claim 1, wherein the inserting of the clock-gating logic comprises:
determining whether the clock-gating logic violates physical constraints; and
externally waiving of the inserting in cases in which the clock-gating logic is determined to violate physical constraints.

7. The computer-implemented method according to claim 1, further comprising equivalence checking of each of the modules prior to and following the inserting of the clock-gating logic.

8. A computer program product for inserting clock-gating in a register-transfer level (RTL) design, the computer program product comprising one or more computer readable storage media having computer readable program code collectively stored on the one or more computer readable storage media, the computer readable program code being executed by a processor of a computer system to cause the computer system to perform a method comprising:
flattening the RTL design;
identifying modules and state elements in the RTL design;
computing a clock-gating expression for each of the state elements of the RTL design;
selecting terms of the clock-gating expression for each one of the state elements that is traceable to signals in a same one of the modules as the one of the state elements;
determining which clock-gating terms are equivalent to those of other state elements in the RTL design;
clustering state elements with equivalent clock-gating terms into clusters; and
inserting clock-gating logic, which equates to the equivalent clock-gating terms, into the RTL design for each cluster.

9. The computer program product according to claim 8, wherein:
the flattening of the RTL design comprises normalizing the RTL, and
the normalizing of the RTL comprises instantiating each of the state elements.

10. The computer program product according to claim 8, wherein the state elements comprise latches.

11. The computer program product according to claim 8, wherein:
the computing of the clock-gating expression comprises determining clock-gating conditions per state element per module via a structural analysis, and
the determining of the clock-gating conditions comprises looking for a feedback loop and an associated MUXing structure.

12. The computer program product according to claim 8, wherein the clustering is executed across hierarchies.

13. The computer program product according to claim 8, wherein the inserting of the clock-gating logic comprises:
determining whether the clock-gating logic violates physical constraints; and
externally waiving of the inserting in cases in which the clock-gating logic is determined to violate physical constraints.

14. The computer program product according to claim 8, wherein the method further comprises equivalence checking of each of the modules prior to and following the inserting of the clock-gating logic.

15. A computing system comprising:
a processor;
a memory coupled to the processor; and
one or more computer readable storage media coupled to the processor, the one or more computer readable storage media collectively containing instructions that are executed by the processor via the memory to cause the processor to perform steps for inserting clock-gating in a register-transfer level (RTL) design comprising:
flattening the RTL design;
identifying modules and state elements in the RTL design;
computing a clock-gating expression for each of the state elements of the RTL design;
selecting terms of the clock-gating expression for each one of the state elements that is traceable to signals in a same one of the modules as the one of the state elements;
determining which clock-gating terms are equivalent to those of other state elements in the RTL design;
clustering state elements with equivalent clock-gating terms into clusters;
inserting clock-gating logic, which equates to the equivalent clock-gating terms, into the RTL design for each cluster; and
equivalence checking of each of the modules prior to and following the inserting of the clock-gating logic.

16. The computing system according to claim 15, wherein:
the flattening of the RTL design comprises normalizing the RTL, and
the normalizing of the RTL comprises instantiating each of the state elements.

17. The computing system according to claim 15, wherein the state elements comprise latches.

18. The computing system according to claim 15, wherein:
the computing of the clock-gating expression comprises determining clock-gating conditions per state element per module via a structural analysis, and
the determining of the clock-gating conditions comprises looking for a feedback loop and an associated MUXing structure.

19. The computing system according to claim 15, wherein the clustering is executed across hierarchies.

20. The computing system according to claim 15, wherein the inserting of the clock-gating logic comprises:
determining whether the clock-gating logic violates physical constraints; and
externally waiving of the inserting in cases in which the clock-gating logic is determined to violate physical constraints.
